(19) United States
(12) Patent Application Publication
(10) Pub. No.: US 2026/0021577 A1
(43) Pub. Date: Jan. 22, 2026

(54) System, Method, and Computer Program Product for Searching Control Hierarchies for a Dynamic System

(71) Applicant: Carnegie Mellon University, Pittsburgh, PA (US)

(72) Inventors: Ashwin Khadke, Pittsburgh, PA (US); Hartmut Geyer, Pittsburgh, PA (US)

(21) Appl. No.: 19/275,094

(22) Filed: Jul. 21, 2025

Related U.S. Application Data
(60) Provisional application No. 63/673,531, filed on Jul. 19, 2024.
(60) Provisional application No. 63/674,634, filed on Jul. 23, 2024.

(51) Int. Cl. B25J 9/16

(52) U.S. Cl. CPC B25J 9/161; B25J 9/163

(57) ABSTRACT

Provided is a system, method, and device for searching control hierarchies. The system includes a computing device configured to generate at least one control hierarchy comprising a plurality of subsystems of a system to be controlled based on a plurality of neural network-based control sub-policies, each subsystem corresponding to at least one neural network-based control sub-policy arranged in the control hierarchy, search a plurality of control hierarchies based on a fitness value to identify a control hierarchy, generate a control policy for the system to be controlled comprising of neural network-based sub-policies based on the control hierarchy, and control the system based on the control policy.

### CROSS REFERENCE TO RELATED APPLICATIONS

This application claims the benefit of U.S. Provisional Patent Application No. 63/673,531, filed on Jul. 19, 2024, and U.S. Provisional Patent Application No. 63/674,634, filed on Jul. 23, 2024, the disclosures of which are hereby incorporated by reference in their entirety.

### GOVERNMENT RIGHTS NOTICE

This invention was made with government support under 1563807 awarded by the National Science Foundation (NSF). The government has certain rights in the invention.

### BACKGROUND

### 1. Field

This disclosure relates generally to controllable systems and, in non-limiting embodiments, to systems, methods, and apparatuses for searching control hierarchies for a dynamic system.

### 2. Technical Considerations

A policy/controller is a parameterized mapping from the state of a dynamic system to control inputs for regulating the system's behavior. Large policies (that have many parameters) may be used to determine how to control a system in response to a system state. Policy Optimization methods optimize parameters of such policies to optimally (based on some specified cost) regulate a system. Synthesizing policies using such methods can quickly become computationally expensive with increasing complexity (dimensionality of the state and control input spaces) of the dynamic system. Policy Decomposition is a framework that belongs to the class of hierarchical control methods and involves procedurally decomposing the policy optimization of a complex dynamic system, into a hierarchy of smaller, more efficient/tractable, policy optimizations for subsystems of the original system. The policy optimizations for the subsystems yield sub-policies to regulate them, and are assembled together to regulate/control the original dynamic system.

### SUMMARY

According to non-limiting embodiments or aspects, provided is a method comprising: generating at least one control hierarchy comprising a plurality of subsystems of a system to be controlled based on a plurality of neural network-based control sub-policies, each subsystem corresponding to at least one neural network-based control sub-policy arranged in the control hierarchy; searching a plurality of control hierarchies based on a fitness value to identify a control hierarchy;-generate a control policy for the system to be controlled comprising of neural network based sub-policies based on the control hierarchy; and control the system based on the control policy.

In non-limiting embodiments or aspects, searching the plurality of control hierarchies is based on a genetic algorithm comprising: (a) generating the plurality of control hierarchies; (b) determining the fitness value for each control hierarchy based on suboptimality and estimated computational resources to be used; (c) selecting the control hierarchy based on the fitness value; (d) mutating the control hierarchy to result in a mutated set of control hierarchies; (c) crossing over the control hierarchy to result in a crossed over set of control hierarchies; (f) replacing the control hierarchies with the mutated and/or crossed-over control hierarchies; and (g) repeating steps (b)-(f) to result in the control hierarchy. In non-limiting embodiments or aspects, wherein searching the control hierarchies is based on a Monte Carlo algorithm comprising: (a) generating a tree of control hierarchies, each node of the tree representing a control hierarchy; (b) generating new control hierarchies through tree expansion of the tree of control hierarchies; (c) determining a fitness value for each new control hierarchy in the tree of control hierarchies; and (d) selecting a node corresponding to a new control hierarchy based on the fitness value for the new control hierarchy. In non-limiting embodiments or aspects, the system comprises at least one of the following: at least a portion of a biped robot, a robotic manipulator, a quadcopter, a robotic vehicle, or any combination thereof. In non-limiting embodiments or aspects, wherein each sub-policy of the plurality of sub-policies is based on a reduced-order optimal control problem. In non-limiting embodiments or aspects, the fitness value for each control hierarchy is based on a value error for each control hierarchy and a computational cost for computing each control hierarchy. In non-limiting embodiments or aspects, further comprising training each neural network-based control sub-policies arranged in the control hierarchy.

According to non-limiting embodiments or aspects, provided is a system comprising at least one computing device configured to: generate at least one control hierarchy comprising a plurality of subsystems of a system to be controlled based on a plurality of neural network-based control sub-policies, each subsystem corresponding to at least one neural network-based control sub-policy arranged in the control hierarchy; search a plurality of control hierarchies based on a fitness value to identify a control hierarchy; generate a control policy for the system to be controlled comprising of neural network-based sub-policies based on the control hierarchy; and control the system based on the control policy.

In non-limiting embodiments or aspects, wherein searching the control hierarchies is based on a genetic algorithm comprising: (a) generating the plurality of control policies; (b) determining the fitness value for each control hierarchy based on suboptimality and estimated computational resources to be used; (c) selecting the control hierarchy based on the fitness value; (d) mutating the control hierarchy to result in a mutated set of control hierarchies; (c) replacing the control hierarchies with the mutated subset of control hierarchies; and (f) crossing over the subset of control hierarchies to result in a crossed over set of control hierarchies; (g) repeating steps (a)-(f) to result in the control hierarchy. In non-limiting embodiments or aspects, wherein searching the control hierarchies is based on a Monte Carlo algorithm comprising: (a) generating a tree of control hierarchies, each node of the tree representing a control hierarchy; (b) generating new control hierarchies through tree expansion of the tree of control hierarchies; (c) determining a fitness value for each new control hierarchy in the tree of control hierarchies; and (d) selecting a node corresponding to a new control hierarchy based on the fitness value for the new control hierarchy. In non-limiting embodiments or aspects, the system comprises at least one of the following: at least a portion of a biped robot, a robotic manipulator, a quadcopter, a robotic vehicle, or any combination thereof. In non-limiting embodiments or aspects, wherein each sub-policy of the plurality of sub-policies is based on a reduced-order optimal control problem. In non-limiting embodiments or aspects, the fitness value for each control hierarchy is based on a value error for each control hierarchy and a computational cost for computing each control hierarchy. In non-limiting embodiments or aspects, further comprising training each neural network-based control sub-policies based on at least the control policy.

According to non-limiting embodiments or aspects, provided is a computer program product comprising a non-transitory computer-readable medium including program instructions that, when executed by at least one computing device, cause the computing device to: generate at least one control hierarchy comprising a plurality of subsystems of a system to be controlled based on a plurality of neural network-based control sub-policies, each subsystem corresponding to at least one neural network-based control sub-policy arranged in the control hierarchy; search a plurality of control hierarchies based on a fitness value to identify a control hierarchy; generate a control policy for the system to be controlled comprising neural network-based sub-policies based on the control hierarchy; and control the system based on the control policy.

In non-limiting embodiments or aspects, wherein searching the control hierarchies is based on a genetic algorithm comprising: (a) generating the plurality of control hierarchies; (b) determining the fitness value for each control hierarchy based on suboptimality and estimated computational resources to be used; (c) selecting the control hierarchy based on the fitness value; (d) mutating the control hierarchy to result in a mutated set of control hierarchies; (e) crossing over the control hierarchy to result in a crossed over set of control hierarchies; (f) replacing the plurality of combinations with the mutated and/or crossed-over subset of combinations; and (g) repeating steps (a)-(f) to result in the sub-hierarchy. In non-limiting embodiments or aspects, wherein searching the plurality of combinations of sub-policies is based on a Monte Carlo algorithm comprising: (a) generating a tree of control hierarchies, each node of the tree representing a control hierarchy; (b) generating new control hierarchies through tree expansion of the tree of control hierarchies; (c) determining a fitness value for each new control hierarchy in the tree of control hierarchies; and (d) selecting a node corresponding to a new control hierarchy based on the fitness value for the new control hierarchy. In non-limiting embodiments or aspects, the system comprises at least one of the following: at least a portion of a biped robot, a robotic manipulator, a quadcopter, a robotic vehicle, or any combination thereof. In non-limiting embodiments or aspects, wherein each sub-policy of the plurality of sub-policies is based on a reduced-order optimal control problem. In non-limiting embodiments or aspects, the fitness value for each control hierarchy is based on a value error for each control hierarchy and a computational cost for computing each control hierarchy.

Other preferred and non-limiting embodiments or aspects of the present invention will be set forth in the following numbered clauses:

Clause 1: A method comprising: generating at least one control hierarchy comprising a plurality of subsystems of a system to be controlled based on a plurality of neural network-based control sub-policies, each subsystem corresponding to at least one neural network-based control sub-policy arranged in the control hierarchy; searching a plurality of control hierarchies based on a fitness value to identify a control hierarchy; generate a control policy for the system to be controlled comprising of neural network based sub-policies based on the control hierarchy; and control the system based on the control policy.

Clause 2: The method of clause 1, wherein searching the plurality of control hierarchies is based on a genetic algorithm comprising: (a) generating the plurality of control hierarchies; (b) determining the fitness value for each control hierarchy based on suboptimality and estimated computational resources to be used; (c) selecting the control hierarchy based on the fitness value; (d) mutating the control hierarchy to result in a mutated set of control hierarchies; (c) crossing over the control hierarchy to result in a crossed over set of control hierarchies; (f) replacing the control hierarchies with the mutated and/or crossed-over control hierarchies; and (g) repeating steps (b)-(f) to result in the control hierarchy.

Clause 3: The method of any of clauses 1-2 wherein searching the control hierarchies is based on a Monte Carlo algorithm comprising: (a) generating a tree of control hierarchies, each node of the tree representing a control hierarchy; (b) generating new control hierarchies through tree expansion of the tree of control hierarchies; (c) determining a fitness value for each new control hierarchy in the tree of control hierarchies; and (d) selecting a node corresponding to a new control hierarchy based on the fitness value for the new control hierarchy.

Clause 4: The method of any of clauses 1-3, wherein the system comprises at least one of the following: at least a portion of a biped robot, a robotic manipulator, a quadcopter, a robotic vehicle, or any combination thereof.

Clause 5: The method of any of clauses 1-4, wherein each sub-policy of the plurality of sub-policies is based on a reduced-order optimal control problem.

Clause 6: The method of any of clauses 1-5, wherein the fitness value for each control hierarchy is based on a value error for each control hierarchy and a computational cost for computing each control hierarchy.

Clause 7: The method of any of clauses 1-6, further comprising training each neural network-based control sub-policies arranged in the control hierarchy.

Clause 8: A system comprising at least one computing device configured to: generate at least one control hierarchy comprising a plurality of subsystems of a system to be controlled based on a plurality of neural network-based control sub-policies, each subsystem corresponding to at least one neural network-based control sub-policy arranged in the control hierarchy; search a plurality of control hierarchies based on a fitness value to identify a control hierarchy; generate a control policy for the system to be controlled comprising of neural network-based sub-policies based on the control hierarchy; and control the system based on the control policy.

Clause 9: The system of clause 8, wherein searching the control hierarchies is based on a genetic algorithm comprising: (a) generating the plurality of control policies; (b) determining the fitness value for each control hierarchy based on suboptimality and estimated computational resources to be used; (c) selecting the control hierarchy based on the fitness value; (d) mutating the control hierarchy to result in a mutated set of control hierarchies; (c) replacing the control hierarchies with the mutated subset of control hierarchies; and (f) crossing over the subset of control hierarchies to result in a crossed over set of control hierarchies; (g) repeating steps (a)-(f) to result in the control hierarchy.

Clause 10: The system of any of clauses 8-9, wherein searching the control hierarchies is based on a Monte Carlo algorithm comprising: (a) generating a tree of control hierarchies, each node of the tree representing a control hierarchy; (b) generating new control hierarchies through tree expansion of the tree of control hierarchies; (c) determining a fitness value for each new control hierarchy in the tree of control hierarchies; and (d) selecting a node corresponding to a new control hierarchy based on the fitness value for the new control hierarchy.

Clause 11: The system of any of clauses 8-10, wherein the system comprises at least one of the following: at least a portion of a biped robot, a robotic manipulator, a quadcopter, a robotic vehicle, or any combination thereof.

Clause 12: The system of any of clauses 8-11, wherein each sub-policy of the plurality of sub-policies is based on a reduced-order optimal control problem.

Clause 13: The system of any of clauses 8-12, wherein the fitness value for each control hierarchy is based on a value error for each control hierarchy and a computational cost for computing each control hierarchy.

Clause 14: The system of any of clauses 8-13, further comprising training each neural network-based control sub-policies based on at least the control policy.

Clause 15: A computer program product comprising a non-transitory computer-readable medium including program instructions that, when executed by at least one computing device, cause the computing device to: generate at least one control hierarchy comprising a plurality of subsystems of a system to be controlled based on a plurality of neural network-based control sub-policies, each subsystem corresponding to at least one neural network-based control sub-policy arranged in the control hierarchy; search a plurality of control hierarchies based on a fitness value to identify a control hierarchy; generate a control policy for the system to be controlled comprising neural network-based sub-policies based on the control hierarchy; and control the system based on the control policy.

Clause 16: The computer program product of clause 15, wherein searching the control hierarchies is based on a genetic algorithm comprising: (a) generating the plurality of control hierarchies; (b) determining the fitness value for each control hierarchy based on suboptimality and estimated computational resources to be used; (c) selecting the control hierarchy based on the fitness value; (d) mutating the control hierarchy to result in a mutated set of control hierarchies; (e) crossing over the control hierarchy to result in a crossed over set of control hierarchies; (f) replacing the plurality of combinations with the mutated and/or crossed-over subset of combinations; and (g) repeating steps (a)-(f) to result in the sub-hierarchy.

Clause 17: The computer program product of any of clauses 15-16, wherein searching the plurality of combinations of sub-policies is based on a Monte Carlo algorithm comprising: (a) generating a tree of control hierarchies, each node of the tree representing a control hierarchy; (b) generating new control hierarchies through tree expansion of the tree of control hierarchies; (c) determining a fitness value for each new control hierarchy in the tree of control hierarchies; and (d) selecting a node corresponding to a new control hierarchy based on the fitness value for the new control hierarchy.

Clause 18: The computer program product of any of clauses 15-17, wherein the system comprises at least one of the following: at least a portion of a biped robot, a robotic manipulator, a quadcopter, a robotic vehicle, or any combination thereof.

Clause 19: The computer program product of any of clauses 15-18, wherein each sub-policy of the plurality of sub-policies is based on a reduced-order optimal control problem.

Clause 20: The computer program product of any of clauses 15-19, wherein the fitness value for each control hierarchy is based on a value error for each control hierarchy and a computational cost for computing each control hierarchy.

These and other features and characteristics of the present disclosure, as well as the methods of operation and functions of the related elements of structures and the combination of parts and economics of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the invention.

### BRIEF DESCRIPTION OF THE DRAWINGS

Additional advantages and details are explained in greater detail below with reference to the non-limiting, exemplary embodiments that are illustrated in the accompanying figures shown in the separate attachment, in which:

FIG. 1 is a schematic diagram of a system for searching control hierarchies according to non-limiting embodiments or aspects;

FIG. 2 is a flow diagram of a method for searching control hierarchies according to non-limiting embodiments or aspects;

FIG. 3 is a flow diagram of a method for searching control hierarchies according to non-limiting embodiments or aspects;

FIG. 4 is a schematic diagram of a system for searching control hierarchies according to non-limiting embodiments or aspects;

FIG. 5 illustrates a schematic diagram of components used in non-limiting embodiments or aspects; and

FIG. 6 illustrates a crossover operator according to non-limiting embodiments or aspects.

### DETAILED DESCRIPTION

It is to be understood that the embodiments may assume various alternative variations and step sequences, except where expressly specified to the contrary. It is also to be understood that the specific devices and processes described in the following specification are simply exemplary embodiments or aspects of the disclosure. Hence, specific dimensions and other physical characteristics related to the embodiments or aspects disclosed herein are not to be considered as limiting. No aspect, component, element, structure, act, step, function, instruction, and/or the like used herein should be construed as critical or essential unless explicitly described as such. Also, as used herein, the articles “a” and “an” are intended to include one or more items and may be used interchangeably with “one or more” and “at least one.” Also, as used herein, the terms “has,” “have,” “having,” or the like are intended to be open-ended terms. Further, the phrase “based on” is intended to mean “based at least partially on” unless explicitly stated otherwise.

As used herein, the terms “communication” and “communicate” refer to the receipt or transfer of one or more signals, messages, commands, or other type of data. For one unit (e.g., any device, system, or component thereof) to be in communication with another unit means that the one unit is able to directly or indirectly receive data from and/or transmit data to the other unit. This may refer to a direct or indirect connection that is wired and/or wireless in nature. Additionally, two units may be in communication with each other even though the data transmitted may be modified, processed, relayed, and/or routed between the first and second unit. For example, a first unit may be in communication with a second unit even though the first unit passively receives data and does not actively transmit data to the second unit. As another example, a first unit may be in communication with a second unit if an intermediary unit processes data from one unit and transmits processed data to the second unit. It will be appreciated that numerous other arrangements are possible.

As used herein, the terms “processor” or “computing device” may refer to one or more electronic devices configured to process data. A processor and/or computing device may include, for example, a Central Processing Unit (CPU), a Graphics Processing Unit (GPU), a microprocessor, a controller, a field programmable gate array (FPGA), and/or any other computational device capable of executing logic. A “computer readable medium” may refer to one or more memory devices or other non-transitory storage mechanisms capable of storing compiled or non-compiled program instructions for execution by one or more processors. Reference to “a processor” or “a computing device” as used herein, may refer to a previously-recited computing device and/or processor that is recited as performing a previous step or function, a different server and/or processor, and/or a combination of computing devices and/or processors. For example, as used in the specification and the claims, a first computing device and/or a first processor that is recited as performing a first step or function may refer to the same or different computing device and/or a processor recited as performing a second step or function.

As used herein, the term “policy decomposition” refers to a method of solving a complex optimization problem for policies by breaking the problem into sub-problems. Policy Decomposition incorporates estimates of closed-loop performance in the process of identifying suitable control hierarchies.

A “policy,” as used herein, refers to an output in response to a state of a system. For example, a policy may be a mapping of multiple states to multiple controls (e.g., actions) such that a policy may be used to identify one or more actions to be performed by a system in response to one or more inputs relating to the state of a system or environment the system is implemented in. In non-limiting embodiments, a policy may define a dynamic control model (e.g., a parameterized function/mapping from the state of the system to control inputs) for a system that determines how to automatically control one or more sub-systems of the system. As an example, in a non-limiting embodiment involving a biped robot, a sub-policy of a policy may specify an action (e.g., moving an appendage at a specified speed) based on a state (e.g., the appendage lifting off the ground or being at a specified angle). It will be appreciated that numerous control actions and states may be used, including but not limited to speed, directionality, orientation (e.g., angle), torque, and/or the like.

The hierarchy of policies are derived from smaller but tractable sub-systems. Policy decomposition estimates a priori how well the closed-loop behavior of different control hierarchies matches the optimal policy.

According to non-limiting embodiments, fewer computational resources may be used to result in an efficient and fast search of hierarchies. Through the use of unique search algorithms and arrangements described herein, hierarchies may be discovered hierarchies that, in comparison to heuristically designed hierarchies, provide improved closed-loop performance or can be computed in minimal time without materially affecting control performance.

As used herein a “controllable system” or “system” may refer to one or more devices configured to be physically controlled based on one or more sub-systems. For example, a controllable system may include a robotic device and the sub-policies may specify directional movements of one or more components (e.g., appendages, joints, and/or the like) that are dependent on one or more other sub-systems or from which one or more other sub-systems depend (e.g., in a hierarchical control schema).

Policy optimization for a complex system can be algorithmically decomposed to an either decoupled or cascaded collection of lower dimensional policy optimizations for subsystems of the full system. Further, estimates of suboptimality in closed-loop control performance for such purely decoupled and cascaded hierarchies can be derived. Non-limiting embodiments utilize a combination of cascading and decoupling strategies. Non-limiting embodiment provide algorithms to efficiently search through the possibilities in a fixed time budget, enabling the automated discovery of hierarchies that suitably trade off the loss in control performance with reduction in required computation to obtain the policies. These improvements are achieved by using a tree-like abstraction that encodes any hierarchy constructed using decoupling and cascading, that prescribes the recipe to compute control policies under such a hierarchy, and enables deriving corresponding suboptimality estimates.

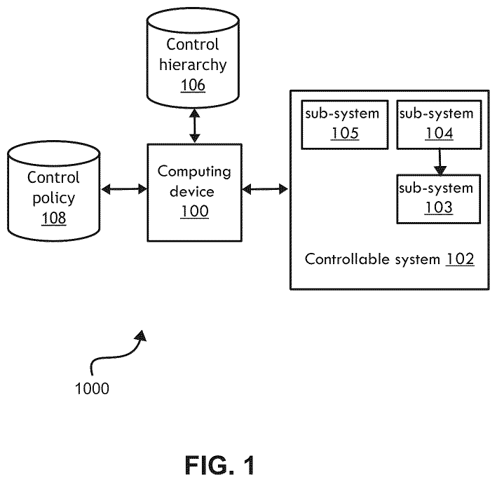

FIG. 1 shows a system 1000 for searching control hierarchies for a dynamic system according to non-limiting embodiments or aspects. A computing device 100 may include one or more computing devices arranged as local computers, server computers, and/or the like. The computing device 100 is in communication with a control hierarchy 106 stored in one or more data storage devices, such as a hard disk, memory, and/or the like. The control hierarchy 106 may include a full dynamic control model of a controllable system 102. A sub-hierarchy may be defined as a combination of sub-trees of the full control hierarchy 106. The computing device 100 may also be in communication with the controllable system 102, which may include a device such as a vehicle, biped robot, robotic manipulator, quadcopter, and/or the like. It will be appreciated by those skilled in the art that various types of controllable systems may be used.

The controllable system 102 may include a plurality of sub-systems 103, 104, 105. FIG. 1 shows three (3) sub-systems for illustration purposes, but it will be appreciated that numerous sub-systems may be present in non-limiting embodiments. The sub-systems 103, 104, 105 may operate in a hierarchical manner such that some sub-systems are dependent on other sub-systems. In FIG. 1, sub-system 103 is dependent from sub-system 104, and sub-system 105 is independent without any dependencies. It will be appreciated that several layers of dependencies and complex hierarchical arrangements of sub-systems may be present in non-limiting embodiments.

In non-limiting embodiments, sub-systems may include discrete and/or combined actions that may include control parameters such as, for example, forward motion, backward motion, turning, stopping, velocity, torque, and/or the like. A quadcopter may have sub-systems for directionality, such as pitch, trust/roll, and yaw. A biped robot may have sub-systems for torque, velocity, orientation, forward motion, backward motion, sideways motion, and/or the like. Some sub-systems may be dependent on other sub-systems and others may be independent. For example, in a quadcopter system, the yaw sub-system may be independent and the thrust/roll may depend from the pitch. A sub-system may be derived from the full dynamic system by locking a suitable subspace of state and/or input spaces.

With continued reference to FIG. 1, the computing device 100 may perform a search of a plurality of hierarchies (each hierarchy is a recipe to compute/optimize policies for the system 102) by calculating the fitness values and identifying one or more hierarchies having a highest fitness value(s). Based on the identified hierarchy 106 the computing device 100 generates a control policy 108 that includes a plurality of sub-policies corresponding to the sub-systems 103, 104, 105, such that each sub-policy corresponds to a sub-system. In non-limiting embodiments, the sub-policies may be individual neural networks. The computing device 100 and/or another computing device may then use the control policy 108 to control the system 102. For example, the control policy 108 may be used by the system 102 for automatic control in response to one or more system states. For example, the control policy 108 may be local and/or remote to the controllable system 102 and used to determine automatic controls in response to system states.

In non-limiting embodiments, the sub-systems represented by individual neural networks may be trained independently or in a cascading manner. For example, the neural networks may be trained in a cascading manner by training one neural network first and using the resulting neural network to train another dependent sub-system (e.g., a dependent neural network). For example, a cascading training technique may involve training one neural network with reinforcement learning (e.g., where the cost function described herein provides the reward) based on performance of the corresponding sub-system, freezing the individual neural network (e.g., such that the weights do not change based on downstream training), and using that trained neural network to train a dependent neural network (e.g., corresponding to a sub-policy for a sub-system that is dependent on the sub-system of the first trained neural network). In non-limiting embodiments, the number of iterations for training each individual neural network may be determined based on a computational cost. The multiple trained neural networks may then work together to process an input.

In non-limiting embodiments a full, dynamic controllable system may be represented by:

$$\dot{x} = f ( x , u ) \qquad ( 1 )$$

with state x and input u. The optimal control policy π*ᵤ(x) for this system minimizes the objective function:

$$J = {\int }^{0 ∞} {e}^{- λ t} c ( x ( t ) , u ( t ) ) dt \qquad ( 2 )$$

which describes the discounted sum of costs accrued over time. Example costs (but not limited to) for optimal regulation control problems where the objective is to drive the system to a fixed desired state x^{d} may be assumed as:

$$c ( x , u ) = {( x - {x}^{d} )}^{T} Q ( x - {x}^{d} ) + {( u - {u}^{d} )}^{T} R ( u - {u}^{d} )$$

where u^{d} is the input that stabilizes the system at x^{d}. The discount factor λ trades-off immediate and future costs. However, the formulation may handle tracking problems where controls to track a desired time-indexed trajectory are to be computed.

In non-limiting embodiments in which the control policy is a neural network and the sub-policies are smaller neural networks that form the larger network, the above problem can be further expanded to cover the finite horizon optimal trajectory problem where an optimal policy π*ᵤ(x) minimizes:

$$J = {\int }_{0}^{{t}_{f}} {e}^{- λ t} c ( x , u , t ) dt \qquad ( 2.1 )$$

$$where c ( x , u , t )$$

$$= {( x - {x}^{d} ( t ) )}^{T} Q ( t ) ( x - {x}^{d} ( t ) )$$

$$+ {( u - {u}^{d} ( t ) )}^{T} R ( t ) ( u - {u}^{d} ( t ) )$$

where x^{d}(t) and u^{d}(t) are the desired state and input trajectories to track, Q and R are the weighting matrices, and λ trades off between the current and future tracking costs.

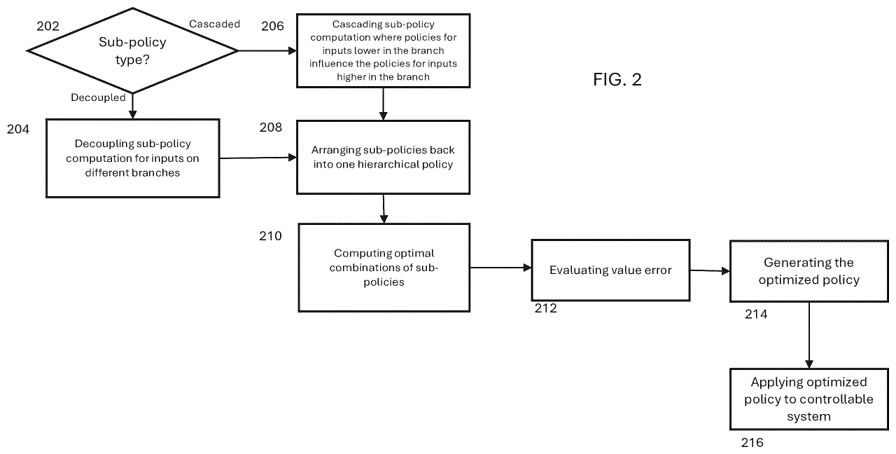

Referring now to FIG. 2, shown is a flow diagram for a method for searching control hierarchies in a dynamic system according to non-limiting embodiments or aspects. The steps shown in FIG. 2 are for example purposes only. It will be appreciated that additional, fewer, different, and/or a different order of steps may be used in some non-limiting embodiments or aspects. In some non-limiting embodiments or aspects, a step may be automatically performed in response to performance and/or completion of a prior step.

Policy Decomposition approximates the search for one high-dimensional policy π*ᵤ(x) with a hierarchy of lower-dimensional sub-policies of smaller optimal control problems that are much faster to compute. At steps 202, 204, and 206, based on the hierarchical structure, control inputs (e.g., nodes in the input space corresponding to sub-policies) may be computed in decoupled form or cascaded form. At step 208 the sub-policies are reassembled into one hierarchical control policy

$${π}_{u ( x )}^{δ}$$

for the entire system. Sup-policy πᵤ_{ᵢ}(xᵢ) is the solution to the optimal control problem defined by dynamics and cost as follows:

$${\dot{x}}_{i} = f \_i ( {x}_{i} , {u}_{i} \vert {\overline{x}}_{i} = \overline{x} {\_i}^{⋀} d , {\overline{u}}_{i} = π \_ ( {\overline{u}}_{i} ) ( {x}_{i} ) )$$

$${c}_{i} ( {x}_{i} , {u}_{i} ) = c ( {x}_{i} , {u}_{i} \vert {\overline{x}}_{i} = \overline{x} {\_i}^{⋀} d , {\overline{u}}_{i} = π \_ ( {\overline{u}}_{i} ) ( {x}_{i} ) )$$

where xᵢ and uᵢ are subsets of x and u, fᵢ only contains the dynamics associated with xᵢ, and the complement state x̅ᵢ=x\x; is assumed to be constant. The complement input

$${\overline{u}}_{i} = u \backslash {u}_{i} = {u}_{i}^{cas} ⋃ {u}_{i}^{dec}$$

includes input

$$( {u}_{i}^{dec} )$$

that are decoupled from uᵢ, and inputs

$$( {u}_{i}^{cas} )$$

that are in cascade with uᵢ. The decoupled inputs are set to zero and sub-policies for the cascaded inputs are used as-is while computing πᵤ_{ᵢ}(xᵢ). In general, (π_{ū}_{ᵢ}xᵢ)=[0, . . . , 0, πᵤⱼ(xⱼ), 0, . . . , 0], where

$${u}_{j} ⊆ {u}_{i}^{cas}$$

are inpuis that appear lower in the cascade to uᵢ, and xⱼ⊆xᵢ. The set of inputs

$${u}_{i}^{dec}$$

are decoupled from uᵢ in the hierarchy, and their absence in the sub-policy calculation is captured by setting them to 0. In some examples, π_{ū}_{ᵢ}(xᵢ) can contain multiple sub-policies, and these sub-policies can themselves be computed in a cascaded or decoupled fashion, so they are known before computing πᵤ_{ᵢ}(xᵢ).

Policy Decomposition may be further defined with the consideration of time-varying policies as a process of computing sub-policies for subsets of inputs as functions of some subset of the system state variables where the sub-policies are also a function of time. As an example, such time-dependent sub-policies may be applied and calculated as described below in non-limiting embodiments in which each sub-policy is represented by a neural network and the full control hierarchy is a larger neural network composed of those smaller neural networks. These sub-policies together form the hierarchical policy

$${π}_{u}^{δ} ( x , t )$$

for the entire system. The sub-policies may be computed by optimizing the behavior of subsystems with a time-varying control objective as follows:

$$\dot{{x}_{i}} = f \_i ( {x}_{i} , {u}_{i} , t \vert {\overline{x}}_{i} = \overline{x} {\_i}^{⋀} d ( t ) , {\overline{u}}_{i} = π \_ ( {\overline{u}}_{i} ) ( {x}_{i} , t ) )$$

$${c}_{i} ( {x}_{i} , {u}_{i} , t ) = c ( {x}_{i} , {u}_{i} , t ⊣ \vert {\overline{x}}_{i} = \overline{x} {\_i}^{⋀} d ( t ) , {\overline{u}}_{i} = π \_ ( {\overline{u}}_{i} ) ( {x}_{i} , t ) )$$

In some non-limiting embodiments, an intuitive abstraction for hierarchies generated by Policy Decomposition may be implemented. A hierarchy δ can be represented using an input-tree as follows:

$${T}^{δ} = ( V , E ) \qquad ( 3 )$$

where all nodes except the root node are tuples of disjoint subsets of inputs and state variables vᵢ=(uᵢ, xᵤ_{ᵢ})∀vᵢ∈V{vᵣₒₒₜ}.

Policy computation for inputs that belong to different branches may be decoupled. Inputs that lie on the same branch are in a cascade where policies for inputs lower in the branch (leaf node being the lowest) influence the policies for inputs higher-up. A sub-tree rooted at node vᵢ characterizes a subsystem with control inputs ui and state: xᵢ=xᵤ_{ᵢ}∪(∪xᵤ_{ᵢ}), where

$${u}_{j} ⊆ {u}_{i}^{cas}$$

and xᵤ are inputs and state variables corresponding to the other nodes in the sub-tree. In some examples, xᵤ_{ᵢ} can be an empty set if it does not belong to a leaf-node. Policies may be computed in a child-first order, starting from leaf nodes, followed by the parents of those nodes, and continuing in that manner. An input-tree prescribes a recipe for computing policies for different subspaces of the input-space (uᵢ) as functions of different subspaces of the state-space (xᵢ). In non-limiting embodiments, the values of uᵢ and xᵢ may be restricted to be subsets of the control inputs and state variables respectively.

At step 212, to assess the quality of the closed-loop behavior for a policy derived using a hierarchy δ, a value error may be introduced as the average difference between value functions V^{δ} and V* of policies obtained with and without the hierarchy:

$${err}^{δ} = \frac{{\int }_{S} ( {V}^{δ} ( x ) - V * ( x ) ) dx}{{\int }_{S} V * ( x ) dx} \qquad ( 4 )$$

where ∫ₛ denotes the integral over state space S. The value function for a policy maps states to the cumulative cost accrued by following the policy after initializing the system from those states and is a measure of the closed-loop performance of a policy. As defined, err^{δ} directly quantifies the suboptimality of the resulting control induced by a hierarchy. The normalized form of value error in (4) includes scaling that allows assessing the suboptimality as a fraction of the optimal value function.

In non-limiting embodiments in which the control policy is a neural network and the sub-policies are smaller neural networks, where the policies are time-varying, the corresponding value functions are also time-varying, resulting in the value error equation to quantify the suboptimality of the hierarchical policies as:

$${err}^{δ} = \frac{{\int }_{0}^{{t}_{f}} {\int }_{S} ( {V}^{δ} ( x ) - V * ( x ) ) dx}{{\int }_{0}^{{t}_{f}} {\int }_{s} V * ( x ) dx} \qquad ( 4.1 )$$

Since exactly evaluating the value error requires knowing the optimal and the hierarchical policies, Linear Quadratic Regulator (LQR) or Control-limited Differential Dynamic Programming (DDP) may be used to estimate the value error. The LQR estimate may be computed for a more general class of hierarchies. The procedure for computing the DDP based estimate may be similarly adapted.

The LQR estimate may be obtained by linearizing the dynamics (1) about the goal state and input,

$$\dot{x} = A ( x - {x}^{d} ) + B ( u - {u}^{d} ) \qquad ( 5 )$$

$$A = \frac{\partial f}{\partial x} {\vert}_{( x {d}_{} , {u}_{d} )} , B = \frac{\partial f}{\partial u} {\vert}_{( x {d}_{} , {u}_{d} )}$$

With assumed quadratic costs, the optimal control of this linear system may be an LQR whose value function V*_{lqr(x)} can be computed by solving the algebraic Riccati equation. The value error estimate for hierarchy δ then becomes:

$${err}_{lqr}^{δ} = \frac{{\int }_{S} ( {V}_{lqr ( x )}^{δ} - {V}_{lqr ( x )}^{*} ) dx}{{\int }_{s} {V}_{lqr ( x )}^{*} dx} \qquad ( 6 )$$

where

$${V}_{lqr ( x )}^{δ}$$

is the value function for the equivalent hierarchical policy of the linear system. Computing

$${V}_{lqr ( x )}^{δ}$$

entails first constructing the hierarchical policy for the linear system, and then solving for its value function. The hierarchical policy may be obtained by deriving sub-policies for the linear subsystems generated by hierarchy δ, in a child-first order as per the corresponding input-tree T^{δ}, and then assembling them into a policy for the full linear system. Sub-policies πᵤ_{ᵢ}₍ₓ_{ᵢ}₎ may be LQR solutions to the corresponding linear subsystems:

$${\dot{x}}_{i} = {A}_{i} ( {x}_{i} - {x}_{i}^{d} ) + {B}_{i} ( {u}_{i} - {u}_{i}^{d} ) \qquad ( 7 )$$

$${A}_{i} = \frac{\partial {f}_{i}}{\partial {x}_{i}} {\vert}_{( {x}^{d} , {u}^{d} )} \frac{\partial {f}_{i}}{\partial {\overline{u}}_{i}} \vert {( {x}^{d} , {u}^{d} )}_{} \cdot \frac{\partial {π}_{{\overline{u}}_{i}}}{\partial {x}_{i}} {\vert}_{{x}_{{d}_{i}}}$$

$${B}_{i} = \frac{\partial {f}_{i}}{\partial {u}_{i}} {\vert}_{( {x}^{d} , {u}^{d} )}$$

where

$${π}_{{\overline{u}}_{i}} ( {x}_{i} ) = [ 0 , … , 0 , {u}_{j}^{d} - {K}_{j} ( {x}_{j} - {x}_{j}^{d} ) , 0 , … , 0 ] .$$

Kⱼ is the LQR solution for a subsystem characterized by

$${u}_{j} ⊆ {u}_{i}^{cas}$$

and xⱼ⊆xᵢ. Inputs

$${u}_{i}^{dec}$$

are sest to 0.

The LQR problem for the subsystem defined by uᵢ and xᵢ may then characterized by Aᵢ, Bᵢ and by cost:

$${c}_{i} ( {x}_{i} , {u}_{i} ) = {( {u}_{i} - {u}_{i}^{d} )}^{T} {R}_{i} ( {u}_{i} - {u}_{i}^{d} ) + {( {x}_{i} - {x}_{i}^{d} )}^{T} ( {Q}_{i} + {[ \begin{matrix}0 & ⋯ & 0 \\ ⋮ & {K}_{j} & ⋮ \\ 0 & ⋯ & 0\end{matrix} ]}^{T} {\overline{R}}_{i} [ \begin{matrix}0 & ⋯ & 0 \\ ⋮ & {K}_{j} & ⋮ \\ 0 & ⋯ & 0\end{matrix} ] ) ( {x}_{i} - {x}_{i}^{d} )$$

where Qᵢ is the appropriate sub-matrix of the original cost function matrix Q, and Rᵢ and R̅ᵢ are sub-matrices of R corresponding to uᵢ and ūᵢ, respectively. M is a matrix composed of LQR gains Kⱼ placed appropriately to match the dimensions.

The hierarchical policy for the linear system may be viewed as a linear controller:

$${π}_{u}^{δ} ( x ) = {u}^{d} - {K}^{δ ( x - {x}^{d} )}$$

whose gain K^{δ} is a block matrix composed of subsystem LQR gains Kᵢ, and the value function is:

$${V}_{lqr ( x )}^{δ} = {( x - {x}^{d} )}^{T} {P}^{δ} ( x - {x}^{d} ) \qquad ( 8 )$$

where P^{δ} is the solution of the Lyapunov equation,

$${( A - {BK}^{δ} - \frac{λ I}{2} )}^{T} {P}^{δ} + {P}^{δ} ( A - {BK}^{δ} - \frac{λ I}{2} ) + Q + {( {K}^{δ} )}^{T} {RK}^{δ} = 0$$

In non-limiting embodiments in which the control policy is a neural network and the sub-policies are smaller neural networks, where the policies are time-varying, a finite horizon time-varying formulation may be considered, and the linearized dynamics of the system may be constructed as:

$$A ( t ) = \frac{\partial f}{\partial x} {\vert}_{( x {d}^{} ( t ) , {u}^{d} ( t ) )} , B ( t ) = \frac{\partial f}{\partial u} {\vert}_{( {x}^{d} ( t ) , {u}^{d} ( t ) )}$$

The time-varying LQ estimate of the optimal value function then becomes

$${V}_{lqr}^{*} ( x , t ) = {( x - {x}^{d} ( t ) )}^{T} P ( t ) ( x - {x}^{d} ( t ) ) \qquad ( 9 )$$

$${π}_{{u}_{lqr}}^{*} ( x , t ) = {u}^{d} ( t ) - {K}^{*} ( t ) ( x - {x}^{d} ( t ) ) ,$$

$$where {K}^{*} ( t ) = {R}^{- 1} {B ( t )}^{T} P ( t ) - P ( t ) = Q + {( A ( t ) - \frac{λ I}{2} )}^{T} P ( t ) + P ( t ) ( A ( t ) - \frac{λ I}{2} ) - P ( t ) B ( t ) {R}^{- 1} {B}^{T} ( t ) P ( t ) ,$$

$$s . t . P ( {t}_{f} ) = Q ( {t}_{f} )$$

The hierarchical policy for the time-invariant case may be

$${π}_{{u}_{lqr}}^{δ} ( x , t ) = {u}^{d} ( t ) - {K}^{δ} ( t ) ( x - {x}^{d} ( t ) ) ,$$

where K^{δ}(t) is a time-varying block matrix composed of linear sub-policies derived from time-varying LQR solutions for the corresponding linear subsystems:

$${A}_{i} ( t ) = \frac{\partial {f}_{i}}{\partial {x}_{i}} {\vert}_{( {x}^{d} ( t ) , {u}^{d} ( t ) )} + \frac{\partial {f}_{i}}{\partial {\overline{u}}_{i}} \vert {( {x}^{d} ( t ) , {u}^{d} ( t ) )}_{} \cdot \frac{\partial {π}_{{\overline{u}}_{i}}}{\partial {x}_{i}} {\vert}_{{x}_{{d}_{i}} ( t )}$$

$${B}_{i} ( t ) = \frac{\partial {f}_{i}}{\partial {u}_{i}} {\vert}_{( {x}^{d} ( t ) , {u}^{d} ( t ) )}$$

where

$${π}_{{\overline{u}}_{i}} ( {x}_{i} , t ) = [ 0 , … , 0 , {u}_{j}^{d} ( t ) - {K}_{j} ( t ) ( {x}_{j} - {x}_{j}^{d} ( t ) ) , 0 , … 0 ]$$

and Kⱼ(t) is the LQR solutions for the subsystems in cascade with the ith subsystem. The time-varying LQR solution for the ith subsystem is then characterized by Aᵢ(t), Bᵢ(t) and cost

$${c}_{i} ( {x}_{i} , {u}_{i} , t ) = {( {u}_{i} - {u}_{i}^{d} ( t ) )}^{T} {R}_{i} ( t ) ( {u}_{i} - {u}_{i}^{d} ( t ) ) + {( {x}_{i} - {x}_{i}^{d} ( t ) )}^{T} ( {Q}_{i} ( t ) + {[ \begin{matrix}0 & … & 0 \\ ⋮ & {K}_{j} ( t ) & ⋮ \\ 0 & … & 0\end{matrix} ]}^{T} {\overline{R}}_{i} ( t ) [ \begin{matrix}0 & … & 0 \\ ⋮ & {K}_{j} ( t ) & ⋮ \\ 0 & … & 0\end{matrix} ] ) ( {x}_{i} - {x}_{i}^{d} ( t ) )$$

where Qᵢ(t) is the appropriate sub-matrix of the original cost function matrix Q(t), and Rᵢ(t) and R̅ᵢ(t) are sub-matrices of R(t) corresponding to uᵢ and ūᵢ respectively. The value function estimate for the hierarchical policy when considering time varying policies then resolves to

$${V}_{lqr}^{δ} ( x , t , ) = {( x - {x}^{d} ( t ) )}^{T} {P}^{δ} ( t ) ( x - {x}^{d} ( t ) ) - {\dot{P}}^{δ} = Q + {{K}^{δ} ( t )}^{T} {RK}^{δ} ( t ) + {( A ( t ) - B ( t ) {K}^{δ} ( t ) - \frac{λ I}{2} )}^{T} {P}^{δ} ( t ) + {P}^{δ} ( t ) ( A ( t ) - B ( t ) {K}^{δ} ( t ) - \frac{λ I}{2} ) , \qquad ( 10 )$$

$$where {P}^{δ} ( {t}_{f} ) = Q$$

In non-limiting embodiments, approximations to the optimal and hierarchical policies in the time-varying approach to derivation may be based on a nearest neighbor look-up with trajectories of the full system and appropriate subsystems, with the nearest neighbor strategy being time conditioned as follows:

$${s}^{†} ( t ) = {arg min}_{s} {‖ {X}_{i}^{s} ( {t}^{†} ) - {x}_{i} ‖}_{2} , where {t}^{†} = {arg min}_{{t}^{′}} \vert {t}^{′} - t \vert \qquad ( 11 )$$

where t′ are the time instances along the discrete-time trajectories

$${X}_{i}^{s} .$$

The estimates of the value function of the optimal and hierarchical policies may be obtained by rolling out trajectories with these approximated policies.

At step 214, an optimized control policy is generated for the system to be controlled based on the control hierarchy (e.g., composed of multiple sub-hierarchies identified in the search process) determined to be the most optimal and/or having the lowest value error. For example, the policies derived from the control hierarchy are used as the control policy to control the system at step 216.

In non-limiting embodiments, policy decomposition may be applied towards training neural network policies. For example, such an approach may utilize on-policy actor-critic methods, which includes a class of algorithms to simultaneously train policies (actor) and value functions (critic) for an optimal control problem. The on-policy actor-critic methods iterate between two phases: (1) Monte Carlo rollouts with the existing policy to collect interaction data, and (2) updating the policy and value function using temporal differences learning. Most of the computation may occur during forward passes to the actor and critic, simulating the dynamics of the underlining controllable system, and computing gradients to update the policy and value function. As the network size grows, most of the computing effort is spent in the forward pass and the gradient computation steps which scale linearly with the number of weights, which motivates the use of smaller neural networks to represent sub-policies. The number of hidden units may be scaled proportionally to the dimension of the input and state subspaces of a subsystem in the neural network sub-policies, shown as the following transformation:

$$[ {h}_{1} , … , {h}_{N} ] \to [ {h}_{1} , … , {h}_{N} ] \times \frac{dim ( {x}_{i} ) \times dim ( {u}_{i} )}{dim ( x ) \times dim ( u )}$$

where [h₁, . . . , h_{N}] is the number of hidden units in the full policy and

$$[ {h}_{1} , … , {h}_{N} ] \times \frac{dim ( {x}_{i} ) \times dim ( {u}_{i} )}{dim ( x ) \times dim ( u )}$$

is the number of hidden units in the ith sub-policy.

When training neural networks to approximate optimal policy and proportionally scaled smaller networks for hierarchical policies, the hierarchical policies may require more environment interactions to train in comparison to the full policy. For larger neural network sizes, in the regime where neural network inference and gradient estimation require more computation than simulating the environment, the hierarchical policies, which employ smaller networks, may require less wall-clock time to train.

The below algorithm shows a non-limiting implementation of an on-policy actor-critic method:

Algorithm OnPolicyActorCritic(System_{info},
stepₘₐₓ, rollout_length, epochₘₐₓ, batchₘₐₓ)

| 1: | step ← 0 | |
|---|---|---|
| 2: | buffer ← [ ] | |
| 3: | while step < stepₘₐₓ do | |
| 4: | α ← π_{θ}(s) | [symbol] forward pass actor |
| 5: | s′, r ← simulate(System_{info}, α) | [symbol] step |
| 6: | υ′ ← V_{Φ}(s′) | [symbol] forward pass critic |
| 7: | buffer.append(s, α, r, s′, υ′) | |
| 8: | step ← step + 1 | |
| 9: | if Modulo(step, rollout_length) == 0 then | |
| 10: | for epoch, batch = 1, 1 to epochₘₐₓ, batchₘₐₓ do | |
| 11: | loss, gradient ← compute_loss(buffer, batch) | [symbol] backward pass |

| | |
|---|---|
| 12: | π_{θ}, V_{Φ} ← update(π_{θ}, V_{Φ}, gradient) |
| 13: | end for |
| 14: | buffer ← [ ] |
| 15: | end if |
| 16: | end while |

The following table shows how the time required to train policies scales with increasing size in a non-limiting implementation of a quadcopter as the controllable system:

| | time | | | steps to |
|---|---|---|---|---|
| | (sec/20 million steps) | | | converge |
| #hidden units | forward | gradient | simulation | (million) |
| [256, 256, 256] | 49.4 | 71.5 | | 24.47 |
| [512, 512, 512] | 50.8 | 133.2 | | 18.48 |
| [1024, 1024, 1024] | 78.9 | 438.3 | 476.1 ± 8.76 | 35.95 |
| [2048, 2048, 2048] | 182.3 | 2028 | | 24.97 |
| [4096, 4096, 4096] | 864.5 | 8779 | | 25.97 |

The above table shows a breakdown of policy computation times for quadcopter control using Proximal Policy Optimization. The cumulative time required for forward pass (policy and value function inference), and computation of gradients for neural network weights when training networks of different sizes is shown. The time required for simulating system dynamics is also shown for comparison. It will be appreciated that different policy computation times may be associated with different systems, types of systems, environments, and/or the like, based on the complexity of individual sub-systems and the overall sub-hierarchy.

In non-limiting embodiments, a Genetic Algorithm (GA) may be used to search the space of sub-hierarchies. A GA evolves a randomly generated initial population of candidates through mutation, selection, and crossover to find promising candidates based on a fitness function. The GA makes minimal assumptions on the underlying fitness landscape and thus can be readily applied to problems in varied domains.

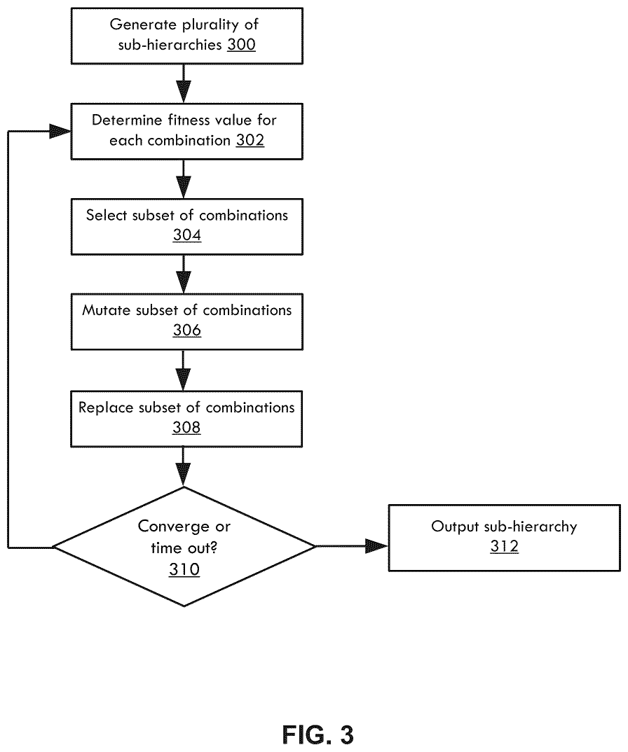

Referring now to FIG. 3, shown is a flow diagram for a method for implementing a genetic algorithm according to non-limiting embodiments or aspects. The steps shown in FIG. 3 are for example purposes only. It will be appreciated that additional, fewer, different, and/or a different order of steps may be used in some non-limiting embodiments or aspects. In some non-limiting embodiments or aspects, a step may be automatically performed in response to performance and/or completion of a prior step.

At step 300 a plurality of sub-hierarchies may be generated. In non-limiting embodiments, the sampling strategy for hierarchies may be tightly linked to the process of constructing corresponding input-trees, which entails partitioning the set of control inputs into groups, arranging the groups in a tree, and then assigning the state variables to nodes of the trec. Probability-proportional-to-size sampling may be employed in each step of the construction process to uniformly draw input-trees. KL-divergence between the uniform distribution and the resulting sample distribution tends to 0 with increasing samples establishing the uniformity of our sampling scheme.

At step 302 a fitness value for each combination may be determined. In non-limiting embodiments, the proposed fitness function for a hierarchy δ may be:

$$F ( δ ) = {F}_{err} ( δ ) \times {F}_{comp} ( δ ) \qquad ( 9 )$$

where Fₑᵣᵣ(δ) and F_{comp}(δ) quantify the suboptimality and the potential reduction in computation respectively. F(δ)∈[0, 1] with lower values indicating a more promising hierarchy.

$${F}_{err} ( δ ) = 1 - exp ( - {err}_{lqr}^{δ} )$$

is the value error estimate scaled to the range [0, 1]. F_{comp}(δ) is the ratio of estimates of floating-point operations used to compute the hierarchical and the optimal policies. Look-up tables may be used to represent policies and Policy Iteration may be used to compute policies. For a hierarchical policy, the individual sub-policies may be look-up tables over appropriate subspaces of the state-space. F_{comp}(δ) is computed using the size of these look-up tables. These values may be used to select a subset of combinations at step 304.

In non-limiting embodiments, for a system with m inputs and n state variables, the number of input groups in an input trec r∈{2, . . . , m}, may be sampled with a probability proportional to the number of such input trees. All the partitions of the inputs may be generated into r groups and one may be picked uniformly at random. The number of leaf-nodes k∈{1, . . . , r}, may be sampled with probability proportional to the number of input-trees with r input groups and k leaf nodes. Prufer codes may be used to sample the tree structure, wherein a Prufer code is an (N−2) character-long sequence of node labels that can be used to bijectively encode a tree with N labeled nodes. The labels for the leaf-nodes may be absent from the encoding, thus an encoding for an input-tree with k leaf-nodes may be generated by uniformly sampling a sequence of length (r−1) with exactly (r−k) distinct entries from {1, . . . , r+1}. To assign state variables to different nodes, a label for every variable from {1, . . . , r} may be sampled, where variables with label i are assigned to node i. If an assignment is invalid or no variables are assigned to leaf-nodes, the labels may be resampled.

In non-limiting embodiments, multiple operations may be utilized for mutating an input-tree into another valid input-tree, including (i) swapping state variables between nodes, (ii) moving one state variable from a node to another, (iii) moving an entire sub-tree, (iv) coupling two nodes into one node, and/or (v) decoupling one node into two nodes. In every GA iteration, a candidate selected for mutation may be modified using only one operator. operations (i), (ii), and (iii) may each have a 25% chance of being applied to a candidate, as an example. With a 25% chance, two distinct inputs may be randomly selected and operators (iv) or (v) may be applied depending on whether they are decoupled or coupled. The subset of combinations selected at step 304 may be mutated based on the above methodology at step 306, which become the new subset of combinations at step 308. At step 310 it is determined whether the process should repeat, until a threshold convergence or time/resource limit is reached. The optimal sub-hierarchy is output at step 312.

In non-limiting embodiments, a hash map may be used to avoid re-evaluating the fitness for previously seen candidates. For example, an associative array may map a unique key for an input-tree to its computed fitness value may be maintained. The key may be composed of two binary matrices C_{m×m} and S_{m×n}, which describe the connectivity and corresponding state variables for nodes of an input-tree. The j^{th} row in C has entries 1 for all inputs that either belong to the same node as uⱼ or its parent node. The i^{th} row in S corresponds to input uⱼ and has entries 1 for all state variables that belong to the same node as uⱼ.

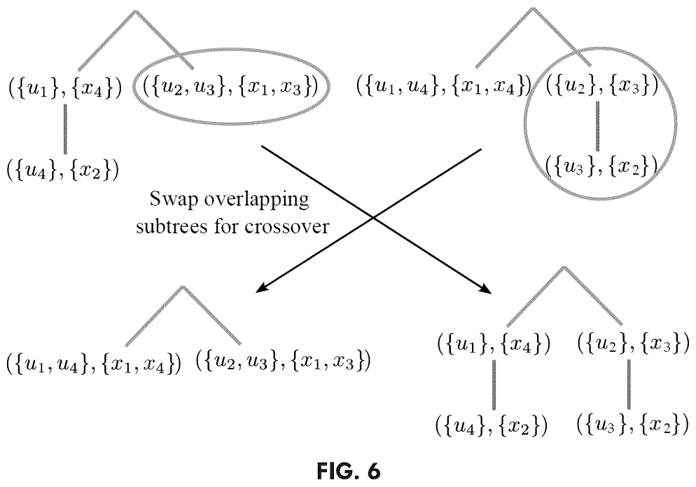

In non-limiting embodiments in which the control policy is a neural network and the sub-policies are smaller neural networks that form the larger network, crossover operators may be used in the GA to combine existing sub-hierarchies into a new candidate sub-hierarchy. Better solutions (e.g., more optimal sub-hierarchies) may be found as the use of crossover operators is increased. Crossover operators may produce better results than mutations in some examples in which neural networks are utilized. A crossover operator may identify compatible hierarchies. An example is shown in FIG. 6 according to non-limiting embodiments. A pair of hierarchies is considered compatible for crossover if they contain overlapping subtrees. Two subtrees are considered overlapping if the set of states and inputs contained in them are the same. Overlapping subtrees may have different structures but are made up of the same set of input and state variables. The outcome of the crossover operation are hierarchies with swapped overlapping subtrees.

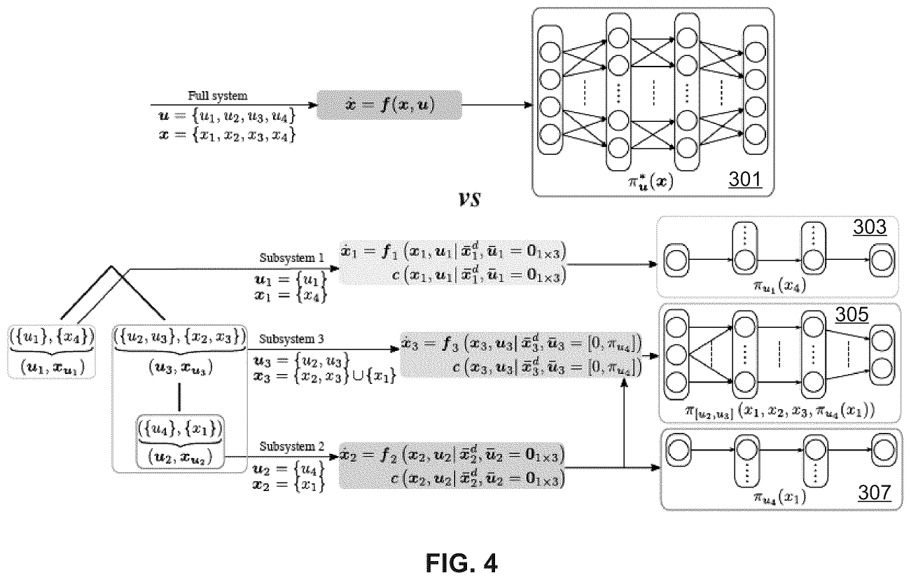

Referring now to FIG. 4, an example of a neural network-based implementation is shown according to non-limiting embodiments or aspects. The optimal policy is represented using a fully connected neural network 301 and the sub-policies are represented using networks 303, 305, 307 with reduced hidden units proportional to the dimensionality of the input and state-space for the subsystem.

In non-limiting embodiments, alternatively or additionally to the GA, a Monte Carlo Tree Search (MCTS) may be used to search the space of hierarchies. An MCTS builds a search tree through continual rollouts (e.g., node expansions), wherein each rollout is a sequence of node expansions starting from the root and continuing until a terminal node is reached. After every rollout, a backup operation is performed to assign/update a value to/for nodes in the explored branch of the search tree. These values guide subsequent rollouts toward promising parts of the search space. In applying an MCTS, the nodes of the tree are each hierarchy (e.g., combinations of multiple sub-policies forming a candidate control hierarchy). This may be viewed as a recipe to decompose the full policy.

In non-limiting embodiments, the MCTS-based hierarchy search may start with every rollout from the original system at the root. Each node in the search tree is an input-tree T^{δ} for some hierarchy δ. The fitness function F(δ) may be used as search criteria. In a rollout, a node expansion entails evaluating the fitness, enumerating the possible children to the node, and then selecting which child to expand next. Expansion further decomposes the sub-system within the control hierarchy of a node. The children are input-trees created by splitting the subsystem corresponding to a leaf in T^{δ} into two cascaded or decoupled subsystems. If no valid child nodes are possible, the rollout is terminated. The UCT strategy is used to decide which child node to expand to next:

$${T}^{{δ}_{expand}} = {arg min}_{{T}^{{δ}^{′}} ∈ childrem ( {T}^{δ} )} Q ( {T}^{{δ}^{′}} ) - \sqrt{\frac{2 ln ( {N}_{{T}^{δ}} + 1 )}{{N}_{{T}^{{δ}^{′}}}}} \qquad ( 10 )$$

where Q(T^{δ′}) is the minimum fitness in the subtree rooted at T^{δ′} and N_{T}_{^{δ′}} denotes the number of times T^{δ′} was visited. Q(T^{δ′}) is initialized to F(δ′) and at the end of each rollout, the values for the nodes visited during the rollout are updated:

$$Q ( {T}^{δ} ) = {min}_{{T}^{{δ}^{′}} ∈ ( \{ {T}^{δ} \} ⋃ childrem ( {T}^{δ} ) )} Q ( {T}^{{δ}^{′}} )$$

starting from the terminal node and going towards the root of the search tree. To prevent redundant computation, a node is removed from consideration in the UCT strategy if all its descendants have been expanded, and an associative array may be maintained to avoid re-evaluating the fitness for previously evaluated input-trees.

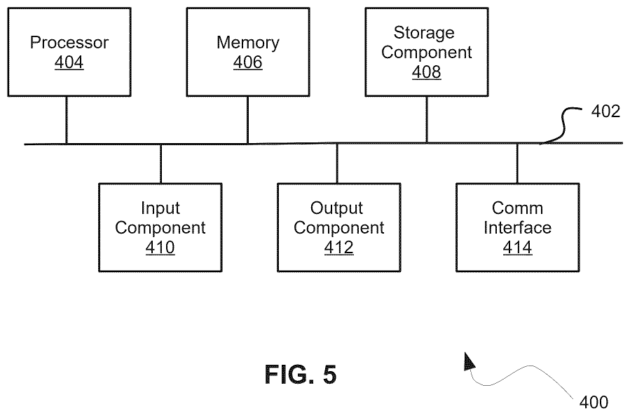

Referring now to FIG. 5, shown is a diagram of example components of a device 400 according to non-limiting embodiments or aspects. Device 400 may correspond to at least one of the computing devices referenced herein (e.g., computing device 102). In non-limiting embodiments or aspects, such systems or devices may include at least one device 400 and/or at least one component of device 400. The number and arrangement of components shown are provided as an example. In non-limiting embodiments or aspects, device 400 may include additional components, fewer components, different components, or differently arranged components than those shown. Additionally, or alternatively, a set of components (e.g., one or more components) of device 400 may perform one or more functions described as being performed by another set of components of device 400.

As shown in FIG. 5, device 400 may include bus 402, processor 404, memory 406, storage component 408, input component 410, output component 412, and communication interface 414. Bus 402 may include a component that permits communication among the components of device 400. In non-limiting embodiments or aspects, processor 404 may be implemented in hardware, firmware, or a combination of hardware and software. For example, processor 404 may include a processor (e.g., a central processing unit (CPU), a graphics processing unit (GPU), an accelerated processing unit (APU), etc.), a microprocessor, a digital signal processor (DSP), and/or any processing component (e.g., a field-programmable gate array (FPGA), an application-specific integrated circuit (ASIC), etc.) that can be programmed to perform a function. Memory 406 may include random access memory (RAM), read only memory (ROM), and/or another type of dynamic or static storage device (e.g., flash memory, magnetic memory, optical memory, etc.) that stores information and/or instructions for use by processor 404.

With continued reference to FIG. 5, storage component 408 may store information and/or software related to the operation and use of device 400. For example, storage component 408 may include a hard disk (e.g., a magnetic disk, an optical disk, a magneto-optic disk, a solid state disk, etc.) and/or another type of computer-readable medium. Input component 410 may include a component that permits device 400 to receive information, such as via user input (e.g., a touch screen display, a keyboard, a keypad, a mouse, a button, a switch, a microphone, etc.). Additionally, or alternatively, input component 410 may include a sensor for sensing information (e.g., a global positioning system (GPS) component, an accelerometer, a gyroscope, an actuator, etc.). Output component 412 may include a component that provides output information from device 400 (e.g., a display, a speaker, one or more light-emitting diodes (LEDs), etc.). Communication interface 414 may include a transceiver-like component (e.g., a transceiver, a separate receiver and transmitter, etc.) that enables device 400 to communicate with other devices, such as via a wired connection, a wireless connection, or a combination of wired and wireless connections. Communication interface 414 may permit device 400 to receive information from another device and/or provide information to another device. For example, communication interface 414 may include an Ethernet interface, an optical interface, a coaxial interface, an infrared interface, a radio frequency (RF) interface, a universal serial bus (USB) interface, a Wi-Fi® interface, a cellular network interface, and/or the like.

Device 400 may perform one or more processes described herein. Device 400 may perform these processes based on processor 404 executing software instructions stored by a computer-readable medium, such as memory 406 and/or storage component 408. A computer-readable medium may include any non-transitory memory device. A memory device includes memory space located inside of a single physical storage device or memory space spread across multiple physical storage devices. Software instructions may be read into memory 406 and/or storage component 408 from another computer-readable medium or from another device via communication interface 414. When executed, software instructions stored in memory 406 and/or storage component 408 may cause processor 404 to perform one or more processes described herein. Additionally, or alternatively, hardwired circuitry may be used in place of or in combination with software instructions to perform one or more processes described herein. Thus, embodiments described herein are not limited to any specific combination of hardware circuitry and software. The term “programmed or configured,” as used herein, refers to an arrangement of software, hardware circuitry, or any combination thereof on one or more devices.

Although embodiments have been described in detail for the purpose of illustration, it is to be understood that such detail is solely for that purpose and that the disclosure is not limited to the disclosed embodiments, but, on the contrary, is intended to cover modifications and equivalent arrangements that are within the spirit and scope of the appended claims. For example, it is to be understood that the present disclosure contemplates that, to the extent possible, one or more features of any embodiment can be combined with one or more features of any other embodiment.

What is claimed is:

1. A method comprising:
generating at least one control hierarchy comprising a plurality of subsystems of a system to be controlled based on a plurality of neural network-based control sub-policies, each subsystem corresponding to at least one neural network-based control sub-policy arranged in the control hierarchy;
searching a plurality of control hierarchies based on a fitness value to identify a control hierarchy;
generate a control policy for the system to be controlled comprising of neural network based sub-policies based on the control hierarchy; and
control the system based on the control policy.

2. The method of claim 1, wherein searching the plurality of control hierarchies is based on a genetic algorithm comprising:
(a) generating the plurality of control hierarchies;
(b) determining the fitness value for each control hierarchy based on suboptimality and estimated computational resources to be used;
(c) selecting the control hierarchy based on the fitness value;
(d) mutating the control hierarchy to result in a mutated set of control hierarchies;
(e) crossing over the control hierarchy to result in a crossed over set of control hierarchies;
(f) replacing the control hierarchies with the mutated and/or crossed-over control hierarchies; and
(g) repeating steps (b)-(f) to result in the control hierarchy.

3. The method of claim 1 wherein searching the control hierarchies is based on a Monte Carlo algorithm comprising:
(a) generating a tree of control hierarchies, each node of the tree representing a control hierarchy;
(b) generating new control hierarchies through tree expansion of the tree of control hierarchies;
(c) determining a fitness value for each new control hierarchy in the tree of control hierarchies; and
(d) selecting a node corresponding to a new control hierarchy based on the fitness value for the new control hierarchy.

4. The method of claim 1, wherein the system comprises at least one of the following: at least a portion of a biped robot, a robotic manipulator, a quadcopter, a robotic vehicle, or any combination thereof.

5. The method of claim 1, wherein each sub-policy of the plurality of sub-policies is based on a reduced-order optimal control problem.

6. The method of claim 1, wherein the fitness value for each control hierarchy is based on a value error for each control hierarchy and a computational cost for computing each control hierarchy.

7. The method of claim 1, further comprising training each neural network-based control sub-policies arranged in the control hierarchy.

8. A system comprising at least one computing device configured to:
generate at least one control hierarchy comprising a plurality of subsystems of a system to be controlled based on a plurality of neural network-based control sub-policies, each subsystem corresponding to at least one neural network-based control sub-policy arranged in the control hierarchy;
search a plurality of control hierarchies based on a fitness value to identify a control hierarchy;
generate a control policy for the system to be controlled comprising of neural network-based sub-policies based on the control hierarchy; and
control the system based on the control policy.

9. The system of claim 8, wherein searching the control hierarchies is based on a genetic algorithm comprising:
(a) generating the plurality of control hierarchies;
(b) determining the fitness value for each control hierarchy based on suboptimality and estimated computational resources to be used;
(c) selecting the control hierarchy based on the fitness value;
(d) mutating the control hierarchy to result in a mutated set of control hierarchies;
(e) replacing the control hierarchies with the mutated subset of control hierarchies;
(f) crossing over the subset of control hierarchies to result in a crossed over set of control hierarchies; and
(g) repeating steps (a)-(f) to result in the control hierarchy.

10. The system of claim 8, wherein searching the control hierarchies is based on a Monte Carlo algorithm comprising:
(a) generating a tree of control hierarchies, each node of the tree representing a control hierarchy;
(b) generating new control hierarchies through tree expansion of the tree of control hierarchies;
(c) determining a fitness value for each new control hierarchy in the tree of control hierarchies; and
(d) selecting a node corresponding to a new control hierarchy based on the fitness value for the new control hierarchy.

11. The system of claim 8, wherein the system comprises at least one of the following: at least a portion of a biped robot, a robotic manipulator, a quadcopter, a robotic vehicle, or any combination thereof.

12. The system of claim 8, wherein each sub-policy of the plurality of sub-policies is based on a reduced-order optimal control problem.

13. The system of claim 8, wherein the fitness value for each control hierarchy is based on a value error for each control hierarchy and a computational cost for computing each control hierarchy.

14. The system of claim 8, further comprising training each neural network-based control sub-policies based on at least the control hierarchy.

15. A computer program product comprising a non-transitory computer-readable medium including program instructions that, when executed by at least one computing device, cause the computing device to:
generate at least one control hierarchy comprising a plurality of subsystems of a system to be controlled based on a plurality of neural network-based control sub-policies, each subsystem corresponding to at least one neural network-based control sub-policy arranged in the control hierarchy;
search a plurality of control hierarchies based on a fitness value to identify a control hierarchy;
generate a control policy for the system to be controlled comprising neural network-based sub-policies based on the control hierarchy; and
control the system based on the control policy.

16. The computer program product of claim 15, wherein searching the control hierarchies is based on a genetic algorithm comprising:
(a) generating the plurality of control hierarchies;
(b) determining the fitness value for each control hierarchy based on suboptimality and estimated computational resources to be used;
(c) selecting the control hierarchy based on the fitness value;
(d) mutating the control hierarchy to result in a mutated set of control hierarchies;
(e) crossing over the control hierarchy to result in a crossed over set of control hierarchies;
(f) replacing the plurality of control hierarchies with the mutated and/or crossed-over set of control hierarchies; and
(g) repeating steps (b)-(f) to result in the control hierarchy.

17. The computer program product of claim 15, wherein searching the plurality of combinations of sub-policies is based on a Monte Carlo algorithm comprising:
(a) generating a tree of control hierarchies, each node of the tree representing a control hierarchy;
(b) generating new control hierarchies through tree expansion of the tree of control hierarchies;
(c) determining a fitness value for each new control hierarchy in the tree of control hierarchies; and
(d) selecting a node corresponding to a new control hierarchy based on the fitness value for the new control hierarchy.

18. The computer program product of claim 15, wherein the system comprises at least one of the following: at least a portion of a biped robot, a robotic manipulator, a quadcopter, a robotic vehicle, or any combination thereof.

19. The computer program product of claim 15, wherein each sub-policy of the plurality of sub-policies is based on a reduced-order optimal control problem.

20. The computer program product of claim 15, wherein the fitness value for each control hierarchy is based on a value error for each control hierarchy and a computational cost for computing each control hierarchy.
